(19) United States
(12) Patent Application Publication
(10) Pub. No.: US 2020/0007700 A1
(43) Pub. Date: Jan. 2, 2020

(54) INFORMATION PROCESSING DEVICE, INFORMATION PROCESSING METHOD, AND NON-TRANSITORY COMPUTER READABLE MEDIUM

(71) Applicants: PFU Limited, Ishikawa (JP); Silex Technology, Inc., Kyoto (JP)

(72) Inventors: Osamu MIYAKAWA, Ishikawa (JP); Hitoshi MATSUO, Ishikawa (JP); Yasuo UEDA, Kyoto (JP)

(21) Appl. No.: 16/144,702

(22) Filed: Sep. 27, 2018

(30) Foreign Application Priority Data
Jun. 28, 2018 (JP) 2018-122647

(51) Int. Cl. H04N 1/00; H04W 48/16; H04W 8/00; H04W 76/10

(52) U.S. Cl. CPC H04N 1/00228; H04W 76/10; H04W 8/005; H04W 48/16

(57) ABSTRACT

There is provided an information processing device comprising a memory and a processor coupled to the memory and the processor configured to: write channel specifying information for specifying a channel used for radio connection, into the memory; and attempt to establish a radio connection during activation of a radio connection function, by using channel specifying information on a channel used for a last radio connection, out of the channel specifying information written into the memory, wherein the memory is a non-volatile memory, and the processor is further configured to write only channel specifying information on the currently employed channel into the non-volatile memory when the information processing device is instructed to disconnect a power supply.

### CROSS-REFERENCE TO RELATED APPLICATIONS

This application is based on and claims priority under 35 USC 119 from Japanese Patent Application No. 2018-122647 filed Jun. 28, 2018.

### FIELD

The present invention relates to an information processing device, an information processing method, and a non-transitory computer readable medium.

### BACKGROUND ART

For example, PCT International Publication No. WO 2016/147670 discloses a communication system in which in radio communication between GO and a child device in a Wi-Fi Direct, a channel list including information on a first channel and a second channel is held, and when a handshake process using the first channel is failed a predetermined number of times, the handshake process is executed by using the second channel.

Further, Japanese Patent Application Laid-Open (JP-A) No. 2016-052017 discloses a radiocommunication device configured to perform radio communication with a partner device, in which channel selection order information representing a priority order according to a communication quality of each of a plurality of channels in a frequency band used for radio communication is stored, and a channel is changed by selecting a channel in the order of descending priorities indicated by the channel selection order information.

### SUMMARY OF THE INVENTION

According to an aspect of the invention, there is provided an information processing device comprising a memory; and a processor coupled to the memory and the processor configured to write channel specifying information for specifying a channel used for radio connection into the memory; and attempt to establish a radio connection during activation of a radio connection function, by using channel specifying information on a channel used for a last radio connection, out of the channel specifying information written into the memory.

According to another aspect of the invention, there is provided an information processing method comprising the steps of writing channel specifying information for specifying a channel used for radio connection, into a non-volatile memory; and attempting a radio connection during activation of a radio connection function, by using channel specifying information on a channel used for a last radio connection, out of the channel specifying information written into the non-volatile memory.

According to another aspect of the invention, there is provided a non-transitory computer-readable recording medium storing thereon a computer program that causes a computer to perform a method comprising: writing channel specifying information for specifying a channel used for radio connection, into a non-volatile memory; and attempting a radio connection during activation of a radio connection function, by using channel specifying information on a channel used for a last radio connection, out of the channel specifying information written into the non-volatile memory.

### BRIEF DESCRIPTION OF THE DRAWINGS

Exemplary embodiments of the present invention will be described in detail based on the following figures.

FIG. 1 is an example of the whole configuration of a scanner sharing system 1.

FIG. 2 is an example of a hardware configuration and a software configuration of the information processing unit 20 incorporated in the scanner device 2.

FIG. 3 is an example of a function configuration of the Wi-Fi control application 420.

FIG. 4 is a flowchart for describing a device activation process (S10) of the scanner device 2 with a focus on the radio connection function.

FIG. 5 is a flowchart for describing a device shutdown process (S20) of the scanner device 2 with a focus on the radio connection function.

FIG. 6 is a flowchart for describing a channel updating process (S30) of the Wi-Fi driver 404.

### DESCRIPTION OF EMBODIMENTS

### Background and Summary

Conventionally, it is considered that a timing when an activation of an information processing device is completed is a time point at which a hardware is initialized and reading of a necessary software such as an operating system is completed.

However, with the advent of an online authentication, a cloud cooperation, a thin client terminal or the like, there are an increasing number of cases where the information processing device is available only when a network connection is completed. In particular, in a case of a terminal mounted with Wi-Fi, in a normal radio connection sequence, all the channels are sequentially scanned to search a connectable SSID (Service Set IDentifier), and thus, it takes a long period of time from a power supply input to the terminal being available.

Therefore, in an information processing device of the present embodiment, channel specifying information on a channel that was successful in a previous connection is held in a non-volatile memory, and when the power supply is input, this channel is preferentially scanned, it is thus possible to shorten a time required for a radio connection so as to achieve a high-speed activation of the device.

In particular, the information processing device of the present embodiment is an information processing unit 20 incorporated into a scanner device 2. The scanner device 2 is often stationary in use, and thus, a radio connection environment is rarely changed. As a result, it is possible to expect a high-speed device activation effect.

### Embodiment

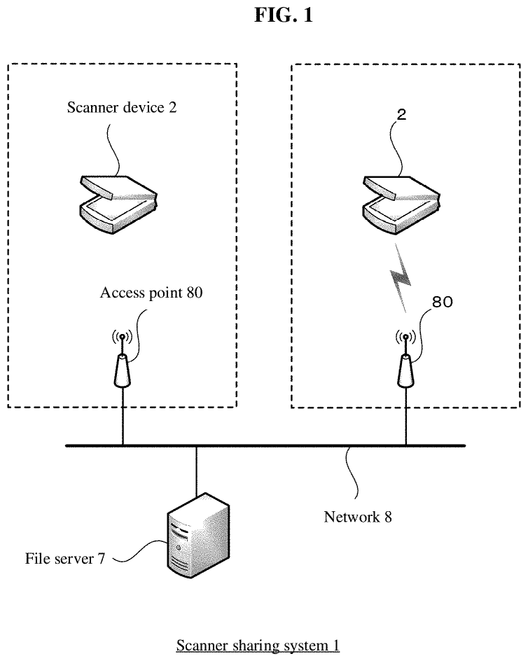

FIG. 1 is an example of the whole configuration of a scanner sharing system 1.

As illustrated in FIG. 1, the scanner sharing system 1 includes a scanner device 2 and a file server 7, and these components are connected to each other via an access point 80 and a network 8. The scanner device 2 is an image reading device configured to read an image to generate image data, and incorporates an information processing unit 20 (described later) configured to process the read image data. The scanner device 2 in the present example is connected through Wi-Fi, via the access point 80, to the network 8, and transmits the read image data, via the network 8, to the file server 7. It is noted that a target to which the image data is transmitted may not only be the file server 7 but also a cloud server, a personal computer, a smartphone, a tablet terminal or the like.

For example, the access point 80 and the scanner device 2 are placed in each of a plurality of rooms, and the scanner device 2 is stationary in each room for a shared use.

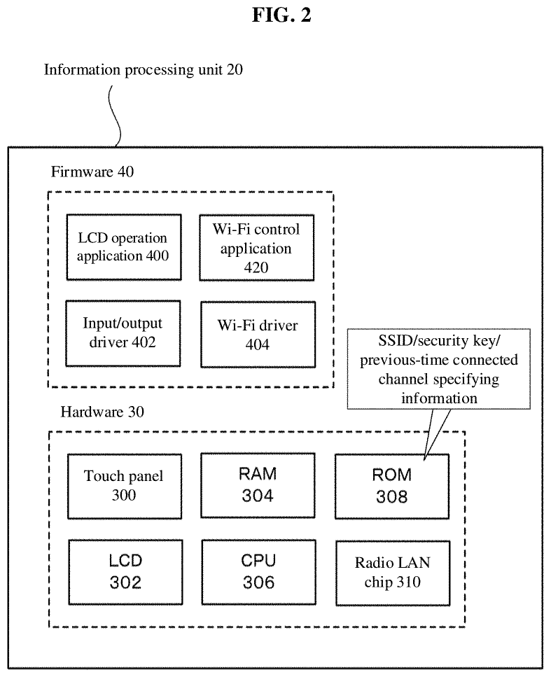

FIG. 2 is an example of a hardware configuration and a software configuration of the information processing unit 20 incorporated in the scanner device 2.

As illustrated in FIG. 2, the information processing unit 20 includes, as a hardware 30, a touch panel 300, a liquid crystal display 302 (LCD 302), a RAM 304, a CPU 306, a ROM 308, and a radio LAN chip 310.

The touch panel 300 is an input device configured to detect a user's touch operation, and placed over the LCD 302.

The LCD 302 is a display device provided with a liquid crystal panel.

The RAM 304 is a volatile memory, and functions as a main storage device.

The CPU 306 is a central processing unit.

The ROM 308 is a non-volatile memory.

The radio LAN chip 310 is a chip for performing a radio connection, and realizes a Wi-Fi connection, for example.

Further, as illustrated in FIG. 2, the information processing unit 20 includes, as a firmware 40, an LCD operation application 400, an input/output driver 402, a Wi-Fi control application 420, and a Wi-Fi driver 404.

The LCD operation application 400 controls the touch panel 300 and the LCD 302 via the input/output driver 402, receives a user input, and displays an input result, for example.

The input/output driver 402 is a driver for the touch panel 300 and the LCD 302.

The Wi-Fi control application 420 controls the radio LAN chip 310 via the Wi-Fi driver 404 to realize the Wi-Fi connection to the access point 80.

The Wi-Fi driver 404 is a driver for the radio LAN chip 310.

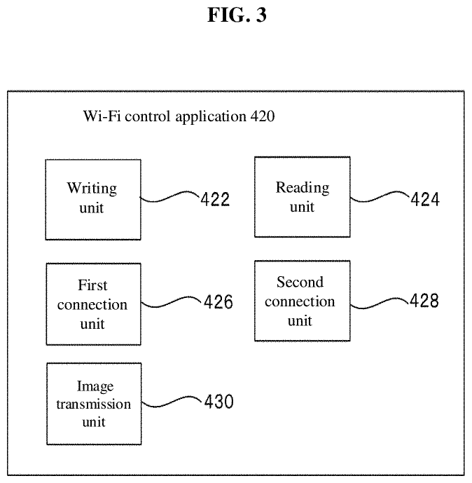

FIG. 3 is an example of a function configuration of the Wi-Fi control application 420.

As illustrated in FIG. 3, the Wi-Fi control application 420 includes a writing unit 422, a reading unit 424, a first connection unit 426, a second connection unit 428, and an image transmission unit 430.

The Wi-Fi control application 420 is stored in a recording medium such as a CD-ROM, for example, and installed in the information processing unit 20 via the recording medium.

It is noted that the Wi-Fi control application 420 may be partially or completely realized by a hardware such as an ASIC. Further, the Wi-Fi control application 420 may be partially or completely realized by borrowing a part of a function of an OS (Operating System).

In the Wi-Fi control application 420, the writing unit 422 writes channel specifying information for specifying a channel used for radio connection, into the ROM 308. More specifically, when the scanner device 2 is instructed to disconnect a power supply, the writing unit 422 writes only the channel specifying information on a channel currently employed for the radio connection, into the ROM 308. When the radio connection is set, the writing unit 422 in the present example writes an SSID and a security key set by a user, into the ROM 308, and when the scanner device 2 is shut down, the writing unit 422 writes the channel specifying information on the channel employed for the radio connection, into the ROM 308. It is noted that the channel specifying information may be written and stored into a non-volatile memory (not illustrated) connected to the radio LAN chip 310.

During activation of a radio connection function, the reading unit 424 reads the channel specifying information from the ROM 308. When the scanner device 2 is activated, the reading unit 424 in the present example reads the SSID, the security key, and the channel specifying information, from the ROM 308.

The first connection unit 426 attempts the radio connection by using fixed channel specified by the channel specifying information. For example, during activation of the radio connection function, the first connection unit 426 uses the channel specifying information on a channel used for the last radio connection, out of the channel specifying information written into the ROM 308, to attempt the radio connection. During activation of the scanner device 2, the first connection unit 426 in the present example uses the SSID, the security key, and the channel specifying information read by the reading unit 424 to instruct the Wi-Fi driver 404 to attempt the radio connection with the access point 80.

The second connection unit 428 scans a plurality of channels to attempt the radio connection. For example, when the first connection unit 426 fails the radio connection, the second connection unit 428 scans a plurality of channels to search a connectable channel. When the first connection unit 426 fails the radio connection, the second connection unit 428 in the present example sequentially scans all the channels, and instructs the Wi-Fi driver 404 to search a connectable channel.

Further, after completion of activation process of the radio connection function, the second connection unit 428 scans a plurality of channels at a predetermined timing, and updates the radio connection. When the activation process of the scanner device 2 is completed and when in an idle state, the second connection unit 428 in the present example scans a plurality of channels, at a timing at which a radio wave intensity of the radio connection is equal to or less than a threshold value, and instructs the Wi-Fi driver 404 to update the radio connection.

The image transmission unit 430 uses the radio connection connected by the first connection unit 426 to externally transmit the image data read by the scanner device 2. The image transmission unit 430 in the present example uses the radio connection connected by the first connection unit 426 or the radio connection connected by the second connection unit 428 to transmit the image data read by the scanner device 2 to the file server 7.

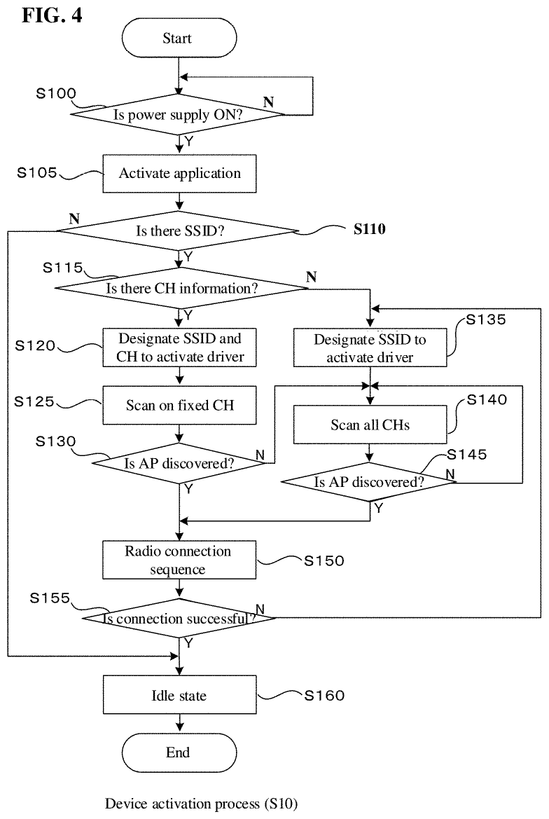

FIG. 4 is a flowchart for describing a device activation process (S10) of the scanner device 2 with a focus on the radio connection function.

As illustrated in FIG. 4, in step 100 (S100), the scanner device 2 waits until an activation instruction is applied from a user (S100: No), each component of the hardware 30 performs an activation process once the activation instruction is applied, and the OS (not illustrated) is activated and then the scanner device 2 shifts to a process of S105.

Instep 105 (S105), the Wi-Fi control application 420 (FIG. 2) is activated.

In step 110 (S110), the reading unit 424 (FIG. 3) of the Wi-Fi control application 420 attempts to read the SSID and the security key from the ROM 308.

When successfully reading the SSID and the security key, the Wi-Fi control application 420 shifts to a process of S115, and when failing to read the SSID and the security key, the Wi-Fi control application 420 shifts to a process of S160.

In step 115 (S115), the reading unit 424 attempts to read the channel specifying information from the ROM 308.

When successfully reading the channel specifying information, the Wi-Fi control application 420 shifts to a process of S120, and when failing to read the channel specifying information, the Wi-Fi control application 420 shifts to a process of S135.

Instep 120 (S120), the first connection unit 426 activates the Wi-Fi driver 404, and hands over the SSID, the security key, and the channel specifying information read by the reading unit 424, to the Wi-Fi driver 404.

In step 125 (S125), according to the SSID, the security key, and the channel specifying information handed over from the first connection unit 426, the Wi-Fi driver 404 scans a fixed channel, and performs scanning for the access point 80 in only the channel specified by the channel specifying information.

In step 130 (S130), when the access point 80 can be discovered as a result of the fixed channel being scanned, the Wi-Fi driver 404 shifts to a process of S150, and when the access point 80 cannot be discovered as a result of the fixed channel being scanned, the Wi-Fi driver 404 shifts to a process of S140.

In step 135 (S135), the second connection unit 428 activates the Wi-Fi driver 404, and hands over the SSID and the security key read by the reading unit 424, to the Wi-Fi driver 404.

In step 140 (S140), according to the SSID and the security key handed over from the second connection unit 428, the Wi-Fi driver 404 implements all-channel scanning to sequentially scan all the channels to search the access point 80.

In step 145 (S145), when the access point 80 can be discovered in any one of the channels through all-channel scanning, the Wi-Fi driver 404 shifts to a process of S150, and when the access point 80 cannot be discovered in any one of the channels, the Wi-Fi driver 404 returns to the process of S140.

In step 150 (S150), the Wi-Fi driver 404 implements a radio connection sequence for the discovered access point 80.

In step 155 (S155), when the Wi-Fi connection by the first connection unit 426 or the second connection unit 428 is successful, the Wi-Fi control application 420 shifts to a process of S160, and when the Wi-Fi connection is failed, shifts to a process of S135.

In step 160 (S160), the scanner device 2 accesses the file server 7 via the radio connection established by the Wi-Fi control application 420 to complete a preparation required for an image reading process, and then, shifts to awaiting state (idle state).

Thus, during activation of the scanner device 2, according to the SSID, the security key, and the channel specifying information written into the ROM 308, the radio connection is attempted by the fixed channel, and when the establishment of the radio connection is failed, the radio connection is established though the all-channel scanning.

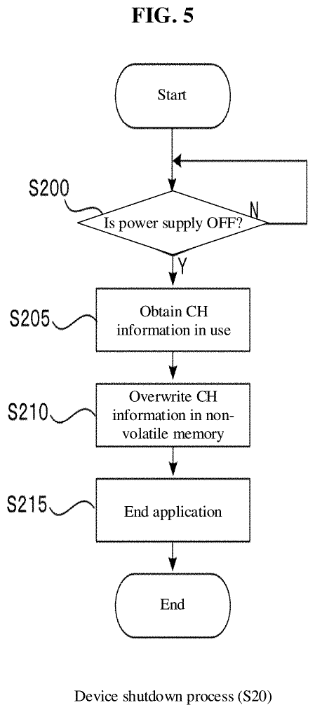

FIG. 5 is a flowchart for describing a device shutdown process (S20) of the scanner device 2 with a focus on the radio connection function.

As illustrated in FIG. 5, in step 200 (S200), the scanner device 2 waits until a shutdown instruction is applied from a user (S200: No), and when the shutdown instruction is applied, shifts to a process of S205.

In step 205 (S205), when the device shutdown is instructed, the Wi-Fi control application 420 (FIG. 2) instructs the Wi-Fi driver 404 to obtain the channel specifying information that is currently in use. In response thereto, the Wi-Fi driver 404 returns the channel specifying information that is currently in use, to the Wi-Fi control application 420.

In step 210 (S210), the writing unit 422 of the Wi-Fi control application 420 (FIG. 3) writes the channel specifying information obtained from the Wi-Fi driver 404, into the ROM 308. During this time, the channel specifying information is overwritten onto the channel specifying information written during the previous shutdown process, and as a result, the last channel specifying information only is held in the ROM 308.

In step 215 (S215), the Wi-Fi control application 420 is shut down, and the scanner device 2 is also shut down.

Thus, during the shutdown of the scanner device 2, the channel specifying information on the channel that has been used is written into the ROM 308.

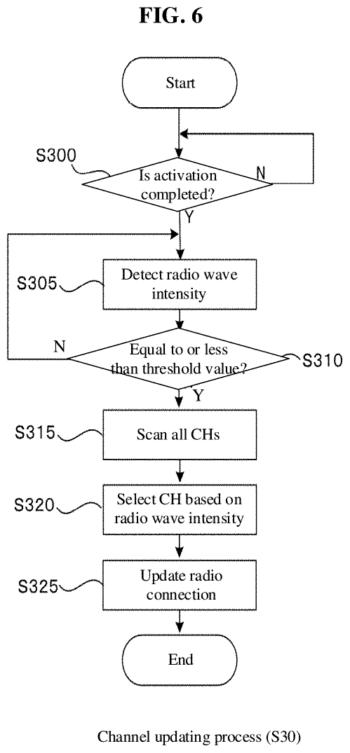

FIG. 6 is a flowchart for describing a channel updating process (S30) of the Wi-Fi driver 404.

As illustrated in FIG. 6, in step 300 (S300), the Wi-Fi driver 404 exclusively performs the device activation process (S10) until the completion of the activation of the scanner device 2 (S300: No), and upon completion of the activation process, shifts to a process of S305 to regularly start the channel updating process (S30) (S300: Yes).

In step 305 (S305), the Wi-Fi driver 404 checks an intensity of a radio wave used in the radio connection with the access point 80.

In step 310 (S310), when the radio wave intensity is equal to or less than a threshold value, the Wi-Fi driver 404 shifts to a process of S315 (S310: Yes), and when the radio wave intensity exceeds the threshold value, returns to the process of S305 (S310: No).

In step 315 (S315), the Wi-Fi driver 404 implements the radio connection sequence of the all-channel scanning.

In step 320 (S320), the Wi-Fi driver 404 selects a channel with a high radio wave intensity, based on a result obtained by scanning all the channels.

In step 325 (S325), the Wi-Fi driver 404 performs a handshake for the radio connection with the access point 80, on the selected channel, so as to implement a Wi-Fi connection process.

It is noted that a timing of the all-channel scanning may be a timing at which radio data communication is not performed during a constant period. Further, when an access point having a radio wave intensity higher by a prescribed value (for example, 10 dBm) or more than the currently used access point is discovered, the Wi-Fi driver 404 may update the radio connection.

As described above, the scanner device 2 of the present embodiment uses the channel specifying information written into the ROM 308 during the previous shutdown to attempt the radio connection by a fixed channel, and thus, it is possible to expect a high-speed radio connection process. In particular, in the scanner device being often stationary in use, the radio environment of the Wi-Fi is not changed greatly, and thus, a high-speed radio connection process can be expected in many cases.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An information processing device comprising:
a memory; and
a processor coupled to the memory, the processor configured to:
write channel specifying information for specifying a channel used for a radio connection, into the memory; and
attempt to establish a radio connection during activation of a radio connection function, by using channel specifying information on a channel used for a last radio connection, out of the channel specifying information written into the memory,
wherein the memory is a non-volatile memory and the processor is further configured to write an SSID and a security key set by a user into the memory, and only channel specifying information on the currently employed channel into the non-volatile memory when the information processing device is instructed to disconnect a power supply.

2. (canceled)

3. The information processing device according to claim 1, further comprising a scanner and the processor is further configured to transmit the image data read by the scanner to an external destination by using the radio connection established by the processor.

4. The information processing device according to claim 1, wherein the processor is further configured to:
scan a plurality of channels, when the processor failed to establish a radio connection or after completion of an activation process of the radio connection function.

5. The information processing device according to claim 4, wherein the processor is further configured to:
scan a plurality of channels after completion of an activation process of the information processing device including the activation process of the radio connection function;
select a channel to be employed based on a radio wave intensity; and
write channel specifying information on the selected channel into the memory.

6. An information processing method comprising the steps of:
writing channel specifying information for specifying a channel used for radio connection, into a non-volatile memory; and
attempting a radio connection during activation of a radio connection function, by using channel specifying information on a channel used for a last radio connection, out of the channel specifying information written into the non-volatile memory,
wherein an SSID and a security key set by a user are written into the non-volatile and only channel specifying information on the currently employed channel is written into the non-volatile memory when the information processing device is instructed to disconnect a power supply.

7. A non-transitory computer-readable recording medium storing thereon a computer program that causes a computer to perform a method comprising:
writing channel specifying information for specifying a channel used for radio connection, into a non-volatile memory; and
attempting a radio connection during activation of a radio connection function, by using channel specifying information on a channel used for a last radio connection, out of
the channel specifying information written into the non-volatile memory,
wherein an SSID and a security key set by a user are written into the non-volatile and only channel specifying information on the currently employed channel is written into the non-volatile memory when the information processing device is instructed to disconnect a power supply.
